(19) United States
(12) Patent Application Publication
(10) Pub. No.: US 2009/0138586 A1
(43) Pub. Date: May 28, 2009

(54) METHOD FOR MANAGING A SERVER LOAD

(75) Inventors: Eric Maschio-Esposito, Fontaine-Etoupefour (FR); Serge Lapeyronie, Limoges (FR); Sebastien Brault, Pleumeur-Bodou (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, Paris (FR)

(21) Appl. No.: 12/280,606

(22) PCT Filed: Feb. 13, 2007
(86) PCT No.: PCT/FR07/50795

§ 371 Date: Aug. 25, 2008

(30) Foreign Application Priority Data
Feb. 24, 2006 (FR) 0650639

(51) Int. Cl. G06F 15/173

(52) U.S. Cl. 709/223

(57) ABSTRACT

Method for managing the load of at least one server able to process the requests sent via a telecommunication network by a plurality of terminals. The method includes the steps of receiving by the server a request originating from a terminal, obtaining an estimation of the load of the server, dispatching to the terminal data intended to bring about the automatic resending by the terminal of the request at a later date, dependent on a forecast relating to the load of the server, the dispatching step being executed when the estimation value is above a threshold value.

The invention relates to a method for managing the load of a server able to process the requests sent via a telecommunication network by a plurality of terminals.

In the field of public networks, data processing servers are sized so as to be capable of processing a significant number of requests originating from remote terminals. Such is the case for example with WEB site servers which are sized as a function of an estimation of the mean activity generated by the site or sites managed by this server.

Now, whatever the processing capacity of a server, the risk nevertheless persists that the number of requests to be processed will, for a very short time period, exceed the capacity of the server. Such a situation usually gives rise to a slump in the performance of the server, the latter no longer being able to respond to the new requests. The requests are then either rejected with an error code, or redirected to a buffer server which returns an information page indicating without further detail that the server cannot accept a new connection and that it would be a good idea for the user to reconnect later.

Finally, in other cases the response times are so long that the web user makes several attempts in vain to access a page of the WEB site, the consequence of which is to increase the number of requests to be processed by the server and therefore to lengthen still further the response delays to a request to access this WEB site.

Various techniques have been formulated to respond to these problems, for example load distribution techniques (also known as “load balancing”). In such an approach, an item of equipment of the network is responsible for distributing the load over a set of servers which is associated with it:
either it assigns a request to a different server on each new request, the servers being selected in turn for this assignment,
or it waits for a server to reach a predefined load threshold in order to assign the new requests to the next server in its list of servers.

However such solutions do not make it possible, in the event of global overload of the set of servers, to guarantee that a request will be processed normally, nor even to guarantee a timescale for processing the requests. Furthermore, for cost reasons, excessive over-sizing of the servers making it possible to manage situations of exceptional load is rarely conceivable.

The aim of the invention is to provide a method for managing the load of a server able to process the requests sent via a telecommunication network by a plurality of terminals, making it possible to manage at lesser cost the isolated overload situations of this server, guaranteeing in particular that the request is taken into account and also the timescale within which this request will be taken into account.

With this aim, the subject of the invention is, according to a first aspect, a method for managing the load of at least one server able to process requests sent via a telecommunication network by a plurality of terminals, the method comprising at least:
a step of the server receiving a request originating from a terminal,
a step of obtaining an estimation value of a load of the server,
a step of dispatching, to said terminal, data intended to bring about an automatic resending, by said terminal and to said server, of said request at a later date, dependent on a forecast relating to the load of the server, said dispatching step being executed if said estimation value is above a threshold value.

According to the invention, there is provision, in the event of overload of the server, to postpone the processing of a request to a later date, by bringing about the automatic resending of the request at this later date. Therefore it is possible to guarantee to the user sending the request that his request will be automatically taken into account and processed later, in particular when the load of the server so allows. Furthermore, the user terminates normally and with no error message his session of consulting the server.

The invention makes it possible to regulate the load of a server by better temporal distribution of the processing of the requests. Isolated overloads of the server are thus anticipated and avoided. Furthermore, the invention can be used in combination with the known load-regulating solutions, in particular with the aforesaid mechanisms for distributing load between several servers.

According to a particular embodiment, the data are intended to bring about a triggering of a timeout having a duration corresponding to an estimation of a standby timescale before the request is taken into account, this estimation being dependent on a forecast relating to the load of the server, the automatic resending taking place on expiry of the timeout.

The date of resending of the request thus stems from the timeout duration. This scheme simplifies the programming of the resending of the request, since it suffices to determine a forecastable standby duration before the request is taken into account and processed and to trigger a timeout having this duration.

According to a particular embodiment, the data are intended to bring about a displaying on said terminal of said estimated standby timescale, the timeout being triggered on condition that said timescale is accepted by a user of the terminal.

In this way, the standby duration is communicated to the user of the terminal sending the request. The user is thus advised of the load problem and of the standby duration to be expected. He can therefore either take advantage of his standby timescale to perform other tasks, or forego connection.

The web user can accept or refuse the standby timescale, and when he accepts it, benefit from the guarantee of being reconnected automatically.

According to a particular embodiment, the data generated by the server comprise a send telltale intended to be inserted into the request during its resending by the terminal.

The send telltale allows the server to know whether a request that it receives is a request which has already been sent previously and which forms the subject of a resend. Management of the resent requests is therefore possible by virtue of this telltale.

According to a particular embodiment, the data generated by the server comprise an information data about a date of first receipt of said request, said information data being intended to be inserted into said request during its resending.

The time-stamping of the requests allows the server to process the requests resent in chronological order in relation to the date of the first connection attempt. This date information data is thus useful for properly taking into account a request with send telltale.

The subject of the invention is also a computer program comprising program code instructions for executing the steps of the method according to the invention when said program is executed on a computer.

According to a second aspect, the subject of the invention is a processing server able to process the requests sent via a telecommunication network by a plurality of terminals, the server comprising:
means for receiving a request originating from a terminal,
means for obtaining an estimation value of a load of the server,
means for, when said estimation value is above a threshold value, dispatching to said terminal data intended to bring about an automatic resending, by said terminal and to said server, of said request at a later date, dependent on a forecast relating to the load of the server.

According to a particular embodiment, the server according to the invention comprises,
means for determining, on receipt of a request, whether it contains a send telltale,
means for processing the requests giving priority to those comprising a send telltale with respect to those not containing one.

Other aims, characteristics and advantages of the invention will become apparent through the description which follows, given solely by way of nonlimiting example, and with reference to the appended drawings in which:

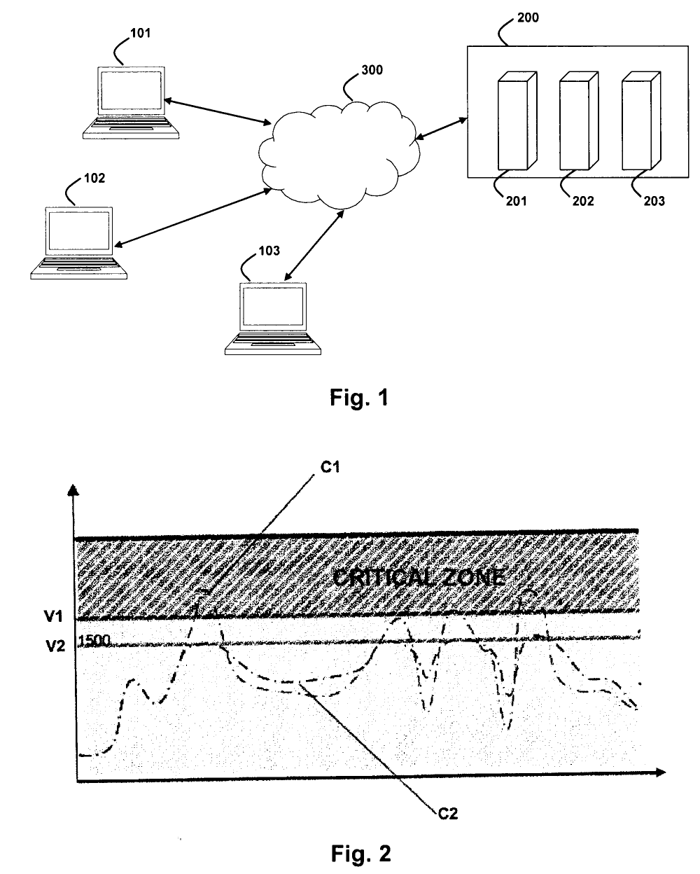

FIG. 1 comprises a diagram of a telecommunication system configuration to which the invention applies;

FIG. 2 illustrates by a chart the manner of operation and the performance of the method according to the invention;

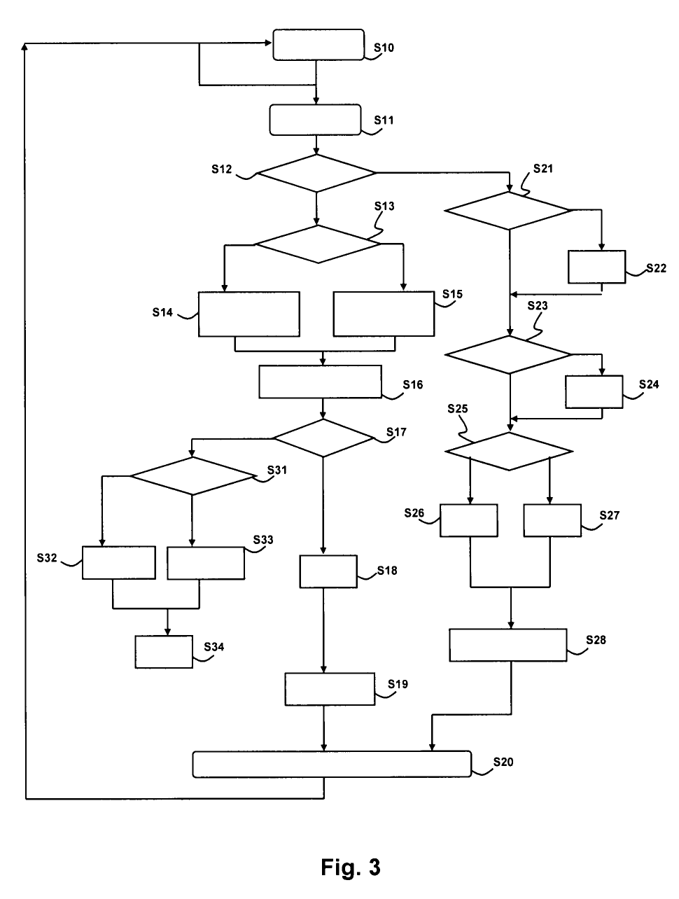

FIG. 3 comprises a flowchart of the method according to the invention.

The telecommunication system represented in FIG. 1 comprises a plurality of terminals 101, 102, 103 able to send requests via the telecommunication network 300 to a set forming the server 200 comprising one or more server machines 201, 202, 203.

The telecommunication network 300 is for example the Internet network, a cellular network of UMTS (Universal Mobile Telecommunication System) type, or any other type of telecommunication network able to transmit data in the form of requests.

The terminals 101, 102, 103 are for example personal computers, third-generation telephones, personal assistants (PDA, Personal Digital Assistant) or any other type of terminal able to send requests to a server. These terminals access the telecommunication network 300.

Subsequently in the description, the invention is described in an embodiment in which the terminals 101, 102, 103 are terminals accessing the Internet network, the server 200 being a WEB site server processing the requests sent by the terminals during sessions of consulting the WEB site or sites associated with the server 200.

Steps S10 to S34 of the method according to the invention are described in detail with reference to FIG. 3. These steps are preferably implemented by a data processor of the server, which processor calls upon programs or subprograms designed to execute the various steps of this method.

In step S10, the server 200 is on standby via a communication interface awaiting a request originating from one of the terminals 101, 102, 103. In step S11, the server 200 receives a request.

In step S12, the server 200 obtains an estimation of the load. This estimation is for example the mean number of requests received per second or the mean number of new user sessions opened per second, the percentage of CPU time commonly used, etc. It therefore relates either to the traffic volume managed by the server, or to a load rate, which rate is measured for example in comparison to its processing capacity. This estimation is determined by a software module for supervising the load of the server, which module is implemented by the server itself or by another server cooperating with the server 200.

If the value of this estimation is greater than a threshold, the server 200 executes step S13, otherwise it executes step S21. The threshold is for example defined on the basis of the maximum critical load that can be absorbed by the server per unit time. This load is the load beyond which the server is no longer able to work with satisfactory response times. Preferably the threshold is less than the maximum critical load, so as to anticipate the appearance of the critical load. The threshold is chosen for example equal to 90% of this maximum critical load.

In step S13, the server tests whether there is a send telltale in the parameters of the request received. The presence of a send telltale in a request makes it possible to determine that this is a request which has already been sent, and which has formed the subject of a resend in accordance with the method according to the invention. Such a send telltale has been generated by the server and transmitted to the terminal so as to be inserted into the request during its resending.

A send telltale takes the form of a set of data. This set of data comprises at least one send telltale identifier, preferably in the form of a unique and nonfalsifiable alphanumeric combination.

The send telltale preferably comprises an indication of a standby timescale associated with the send telltale, expressed in seconds or minutes, as well as the date on which the request was received for the first time by the server.

The send telltale plays as it were the role of a waiting ticket, attesting that a request has already been sent. It makes it possible to mark the request sent and gives information about the sending date and the programmed standby timescale. It therefore allows management of the standby programmed for a request.

These data are identifiable from among the other parameters of the request by means of tags, symbols, specific characters or key words, such as those used in coding the parameters of URLs. In the example below, the identifier of the send telltale ‘45ft672345FR6’ can be identified in the URL by means of the key word ‘ticketweb’:

http://www.korigan.univ.fr/inscript/ticketweb=45ft 672345FR6t.

In the logic for using URLs, the activation of such a link brings about the dispatching of the identifier and of the key word associated with the WEB server managing the requests of the site www.korigan.univ.fr.

The standby timescale associated with a send telltale corresponds to the time period necessary for the server to terminate the processing of the ongoing communication sessions and to process the communication sessions for the requests that have already been placed on standby. This standby timescale is estimated on the basis of a forecast of the load of the server. This load forecast is for example dependent on the number of ongoing communication sessions, the mean duration of a communication session, the number of requests that have been placed on standby and the timescales for placement on standby that have been programmed for these requests. The server thus comprises a statistical analysis module able to calculate the relevant parameters and to regularly update these parameters.

During step S14 or S15 executed following step S13, the server estimates the standby timescale for processing the request on the basis of the server's load forecasts.

If in step S13 the request does not contain a send telltale, the server generates in step S14 a send telltale for this request then executes step S16.

If in step S13 the request contains a send telltale, the server undertakes in step S15 the updating of the send telltale, replacing the initially expected standby timescale with a new timescale. The server thereafter executes step S16.

In step S16, the server dispatches to the terminal in response to the request received a set of data, in the form of an HTML page, intended to bring about the displaying on the terminal of a dialog window. This dialog window makes it possible at one and the same time to display the determined standby timescale and to offer the user of the terminal options for processing the request:
a first option corresponding to the acceptance of the standby timescale together with automatic resending of the request on expiry of the standby timescale;
a second option corresponding to a plea to resend the request at a later date to be chosen by the user;
a third option corresponding to the abandoning of the connection attempt.

The dialog window therefore presents dialog elements, for example in the form of buttons, icons, hypertext links, etc., via which the user is invited to select the chosen option. When the user clicks on one of these elements so as to select one of the options, an information data relating to the chosen option is communicated to the server. The server analyses this information data, stores it and takes account thereof for its load forecasts.

In step S17 the server determines on the basis of the information data received whether the user has accepted the standby timescale.

In the affirmative, the server, in step S18, returns an HTML page to the terminal, comprising program data, typically in script form in the Java language, intended to bring about the execution of a program on the terminal.

In step S19, the script executes and brings about the triggering of a timeout whose duration corresponds to the standby timescale estimated for processing the request. On expiry of the timeout, the script brings about automatic reconnection to the site of the server by the automatic resending of the request to the server, this resent request comprising the send telltale newly generated (case of step S14) or updated (case of step S15).

The script can use one of the following two schemes to instigate reconnection to the site:
either it dispatches an HTTP command of “redirect” type to an enhanced URL comprising the data of a send telltale,
or it dispatches an HTTP command of “post” type so as to return a form containing the parameters of the send telltale.

In both cases, the reconnection procedure is transparent to the user who will, after the expiry timescale, find himself automatically connected to the Internet site.

After step S19, the method terminates at step S20. After step S20, the method resumes at step S10.

In step S31, executed following step S17 in the case where the user has refused the standby timescale, the server determines whether the user has asked for the request to be resent at a later date.

In the negative, in step S32 the server invites the user to reconnect later. The communication session between the terminal and the server then terminates with an HTTP disconnection in step S34, this having the effect of releasing the resources of the server for the processing of other requests.

In the affirmative, in step S33, the server dispatches an electronic message with the data allowing reconnection. These data are preferably in the form of a URL comprising, in the optional data, a send telltale comprising at least one send telltale identifier. Thus, when the user asks for a connection by using the URL thus constituted, the optional data are transmitted to the server together with the request and the server is able to determine that this is a resent request. The communication session between the terminal and the server terminates thereafter with an HTTP disconnection in step S34.

Step S21 is executed following the test of step S12 when the load of the server does not exceed the defined threshold. During step S21, the server determines whether the request that it has just received comprises a send telltale.

In the affirmative, the server deletes this send telltale in step S22 and assigns the request a priority communication session identifier. Such an identifier is used to indicate that the request must be processed by priority with respect to other requests comprising only a simple communication session identifier. Within the context of the invention, the priority communication session identifiers are distinguished from the others for example by the range of value in which they lie.

In step S23, the server determines whether the request comprises a session identifier, and in the negative assigns, during step S24, such an identifier to the request.

In step S25, the server continues processing the request, according to the protocol customarily used. Thus a negotiation is possible to determine whether the rest of the processing should proceed using the HTTP protocol (step S26) or via a new communication session involving the use of the HTTPS protocol (step S27). The presence of a priority communication session identifier does not modify the execution of steps S25, S26, S27 with respect to a situation without priority identifier.

The processing of the request continues thereafter in step S28, during which the server determines on the basis of the communication session identifier whether or not it is dealing with a priority request, and processes by priority the requests comprising a priority communication session identifier.

The date information data associated with the send telltale can be used in several ways.

According to a first variant, this information data is used during the processing of the request, this processing being dependent on the date of first connection. This variant is particularly useful for on-line operations for which a limit date is imposed, for example a declaration of income or enrolment with a university. In this type of situation, the server in fact frequently gets overcongested slightly before the expiry of the imposed limit date. The invention therefore makes it possible to permit connections after the imposed limit date, insofar as this involves automatic resending of a request which was sent for the first time before the imposed limit date. The date information data associated with the send telltale is preferably encoded in a non-unfalsifiable manner so as to avoid any possible fraud.

According to a second variant, the date information data associated with the send telltale allows the server to manage the priority requests in chronological order of receipt, in relation to the date of first connection attempt. In this variant the requests are serialized in a queue. Thus when a user's request is placed in the queue, the user knows that, after the standby timescale that the server has notified him of, he will have priority access to the services offered by this server, reconnection being performed in a transparent and totally automated manner.

The invention thus makes it possible to stagger over time and to schedule the requests for destination received by a server although the latter reaches or is close to its maximum critical load.

The graphic of FIG. 2 illustrates the effectiveness of the send telltale generating system. This graphic comprises two curves C1 and C2 of variation of the load of the server as a function of time. Curve C1, obtained for a server not implementing the invention, shows a large spike in the zone of the load values above a maximum critical value V1. This spike results in severe service degradation.

Curve C2 shows the variation in load obtained for a server implementing the invention for a number of requests and a distribution that are identical to those of curve C1. In this case, as soon as the server load reaches the value V2, the server triggers the method according to the invention and the send telltale generation. As a result of this, curve C2 barely exceeds the threshold value V2, and never reaches the critical threshold value V1. The load spike is absorbed over a wide time period.

According to a preferred implementation, the various steps of the load management method are executed by means of computer program instructions.

Consequently, the invention is also aimed at a computer program on an information medium, this program being suitable for implementation in a computer, this program comprising instructions appropriate to the implementation of a load management method such as mentioned above.

This program can use any programming language, and be in the form of source code, object code, or code intermediate between source code and object code, such as in a partially compiled form, or in any other desirable form.

The invention is also aimed at a computer readable information medium comprising instructions of a computer program such as mentioned above.

The information medium can be any entity or device capable of storing the program. For example, the medium can comprise a storage means, such as a ROM, for example a CDROM or a microelectronic circuit ROM, or else a magnetic recording means, for example a diskette (floppy disk) or a hard disk.

Moreover, the information medium can be a transmissible medium such as an electrical or optical signal, which can be routed via an electrical or optical cable, by radio or by other means. The program according to the invention can be in particular downloaded from a network of Internet type.

Alternatively, the information medium can be an integrated circuit into which the program is incorporated, the circuit being adapted to execute or to be used in the execution of the method in question.

The invention makes it possible to obtain a smoothing effect on the load curve. Despite a slight increase in the number of requests to be processed, the temporal distribution of the load of the server is greatly improved, all the abrupt traffic variations being absorbed smoothly.

The invention is applicable to any type of server, whatever type of requests are processed.

1. A method for managing the load of at least one server able to process requests sent via a telecommunication network by a plurality of terminals, wherein said method comprises at least:
a step of the server receiving a request originating from a terminal,
a step of obtaining an estimation value of a load of the server,
a step of dispatching, to said terminal, data able to bring about an automatic resending, by said terminal and to said server, of said request at a later date, dependent on a forecast relating to the load of the server, said dispatching step being executed if said estimation value is above a threshold value.

2. The method as claimed in claim 1, in which said data are intended to bring about a triggering of a timeout having a duration corresponding to an estimation of a standby timescale before the request is taken into account, said estimation being dependent on a forecast relating to the load of the server, said automatic resending taking place on expiry of said timeout.

3. The method as claimed in claim 2, in which said data are intended to bring about a displaying on said terminal of said estimated standby timescale, said timeout being triggered on condition that said timescale is accepted by a user of the terminal.

4. The method as claimed in claim 1, in which said data comprise a send telltale intended to be inserted into said request during its resending by said terminal.

5. The method as claimed in claim 1, in which said data comprise an information data about a date of first receipt of said request, said information data being intended to be inserted into said request during its resending by said terminal.

6. The method according to claim 4, in which,
the server determines, on receipt of a request, whether it contains a send telltale,
the server processes the requests giving priority to those comprising a send telltale with respect to those not containing one.

7. The method as claimed in claim 6, in which the server processes the resent requests comprising a send telltale in chronological order of receipt on the basis of said date information data.

8. A computer program comprising program code instructions for executing the steps of the method as claimed in claim 1 when said program is executed on a computer.

9. A processing server able to process requests sent via a telecommunication network by a plurality of terminals, wherein said processing server comprises:
means for receiving a request originating from a terminal,
means for obtaining an estimation value of a load of the server,
means for, when said estimation value is above a threshold value, dispatching to said terminal data intended to bring about an automatic resending, by said terminal and to said server, of said request at a later date, dependent on a forecast relating to the load of the server.

10. The server as claimed in claim 9, comprising,
means for determining, on receipt of a request, whether said request contains a send telltale,
means for processing the requests giving priority to those comprising a send telltale with respect to those not containing one.
